(19) United States
(12) Patent Application Publication
(10) Pub. No.: US 2024/0325887 A1
(43) Pub. Date: Oct. 3, 2024

(54) VIRTUAL VEHICLE CONTROL METHOD AND APPARATUS, DEVICE, AND STORAGE MEDIUM

(71) Applicant: Tencent Technology (Shenzhen) Company Limited, Shenzhen (CN)

(72) Inventors: Haosheng XUE, Shenzhen (CN); Jinlong TU, Shenzhen (CN); Zhipeng LUO, Shenzhen (CN)

(21) Appl. No.: 18/739,190

(22) Filed: Jun. 10, 2024

Related U.S. Application Data
(63) Continuation of application No. PCT/CN2023/087825, filed on Apr. 12, 2023.

(30) Foreign Application Priority Data
May 20, 2022 (CN) 202210555884.1

(51) Int. Cl. A63F 13/422; A63F 13/533; A63F 13/57; A63F 13/803

(52) U.S. Cl. CPC A63F 13/422; A63F 13/533; A63F 13/57; A63F 13/803

(57) ABSTRACT

This application discloses a virtual vehicle control method performed by a computer device. The method includes: displaying a virtual vehicle in a drifting state in which a drift angle of the virtual vehicle is greater than a first threshold; in response to an operation on a first brake control, gradually decreasing the drift angle of the virtual vehicle; in response to a first operation on a throttle control, accelerating the virtual vehicle and the decreasing of the drift angle of the virtual vehicle; and when the drift angle of the virtual vehicle is less than the first threshold, controlling the virtual vehicle to exit the drifting state. This application realizes automation of exit from the drifting state, simplifies user operation, and improves drifting-exit efficiency of the virtual vehicle. A drift-accelerated moving manner is provided, so that the moving manner of the virtual vehicle is enriched.

### CROSS-REFERENCE TO RELATED APPLICATIONS

This application is a continuation application of PCT Patent Application No. PCT/CN2023/087825, entitled “VIRTUAL VEHICLE CONTROL METHOD AND APPARATUS, DEVICE, AND STORAGE MEDIUM” filed on Apr. 12, 2023, which claims priority to Chinese Patent Application No. 202210555884.1, entitled “VIRTUAL VEHICLE CONTROL METHOD AND APPARATUS, DEVICE, AND STORAGE MEDIUM” filed on May 20, 2022, both of which are incorporated by reference in their entirety.

### FIELD OF THE TECHNOLOGY

This application relates to the field of computer and Internet technologies, and in particular, to a virtual vehicle control method and apparatus, a device, and a storage medium.

### BACKGROUND OF THE DISCLOSURE

A user can control a virtual vehicle to move in a virtual environment.

In related art, a direction adjustment control, a throttle control, and a drifting control are displayed in a user interface. During movement of the virtual vehicle, a moving direction of the virtual vehicle is adjusted through the direction adjustment control, the virtual vehicle is controlled by touching and holding/long pressing the throttle control to keep accelerating, the virtual vehicle is controlled by releasing the throttle control to stop accelerating, and the virtual vehicle is controlled through the drifting control to enter a drifting state. In addition, during drifting of the virtual vehicle, the user constantly adjusts the moving direction of the virtual vehicle through the direction adjustment control to exit the drifting state.

However, in the foregoing related art, it is cumbersome for the user to operate in controlling the virtual vehicle to exit the drifting state.

### SUMMARY

Embodiments of this application provide a virtual vehicle control method and apparatus, a device, and a storage medium, to simplify user operation and improve drifting-exit efficiency of a virtual vehicle. The technical solutions are as follows:

According to an aspect of embodiments of this application, a virtual vehicle control method is performed by a terminal device. The method includes the following operations:
displaying a virtual vehicle in a drifting state in which a drift angle of the virtual vehicle is greater than a first threshold;
in response to an operation on a first brake control, gradually decreasing the drift angle of the virtual vehicle;
in response to a first operation on a throttle control, accelerating the virtual vehicle and the decreasing of the drift angle of the virtual vehicle; and
when the drift angle of the virtual vehicle is less than the first threshold, controlling the virtual vehicle to exit the drifting state.

According to an aspect of embodiments of this application, an embodiment of this application provides a computer device, including a processor and a memory, the memory having a computer program stored therein, and the computer program being loaded and executed by the processor and causing the computer device to implement the foregoing virtual vehicle control method.

According to an aspect of embodiments of this application, an embodiment of this application provides a non-transitory computer-readable storage medium, having a computer program stored thereon, the computer program being loaded and executed by a processor of a computer device and causing the computer device to implement the foregoing virtual vehicle control method.

The technical solutions provided in embodiments of this application can achieve the following beneficial effects:

A drift angle of a virtual vehicle is controlled, through a first brake control, to be reduced, and when the drift angle of the virtual vehicle is reduced to less than a threshold, in other words, the virtual vehicle is controlled to exit a drifting state, automation of exiting from the drifting state can be implemented, without requiring a user to frequently adjust a moving direction or a vehicle head orientation of the virtual vehicle through a direction adjustment control, thereby simplifying user operation. Increasing a decreasing speed of the drift angle of the virtual vehicle through the throttle control speeds up the exit of the virtual vehicle from the drifting state, and improve drifting-exit efficiency of the virtual vehicle. In addition, controlling the virtual vehicle through the throttle control to accelerate provides a moving manner of drifting and acceleration, so that moving manners of the virtual vehicle is enriched.

### BRIEF DESCRIPTION OF THE DRAWINGS

FIG. 1 is a schematic diagram of a virtual vehicle control system according to an embodiment of this application.

FIG. 2 is an example schematic diagram of a user interface.

FIG. 3 is a flowchart of a virtual vehicle control method according to an embodiment of this application.

FIG. 4 is an example schematic diagram of a user interface.

FIG. 5 is an example schematic diagram of a changing manner of a drift angle.

FIG. 6 is a flowchart of a virtual vehicle control method according to another embodiment of this application.

FIG. 7 is a flowchart of a virtual vehicle control method according to another embodiment of this application.

FIG. 8 to FIG. 12 are example schematic diagrams of a user interface.

FIG. 13 is an example schematic diagram of a virtual vehicle control manner.

FIG. 14 is a flowchart of a virtual vehicle control method according to another embodiment of this application.

FIG. 15 is an example schematic diagram of controlling a virtual vehicle by a user.

FIG. 16 is a block diagram of a virtual vehicle control apparatus according to an embodiment of this application.

FIG. 17 is a block diagram of a virtual vehicle control apparatus according to another embodiment of this application.

FIG. 18 is a block diagram of a structure of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

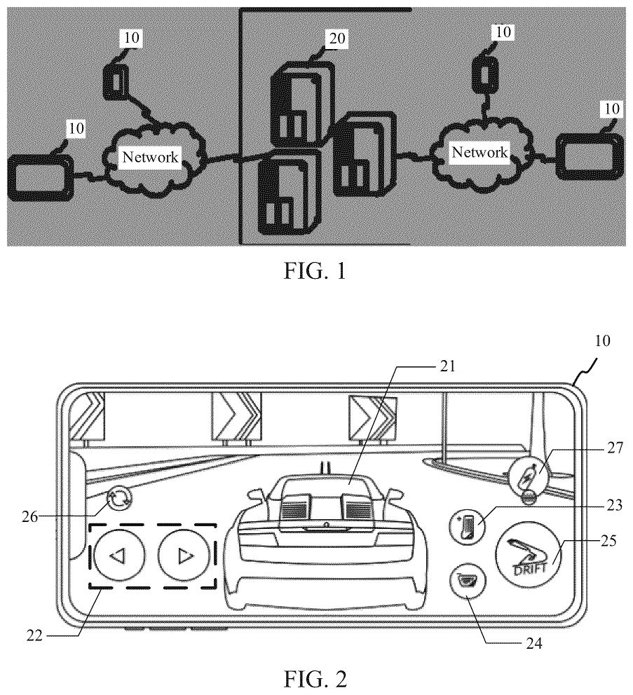

FIG. 1 is a schematic diagram of a virtual vehicle control system according to an embodiment of this application. The virtual vehicle control system may include a terminal device 10 and a server 20.

The terminal device 10 may be an electronic device such as a mobile phone, a tablet computer, a game console, an e-book reader, a multimedia playback device, a wearable device, or a personal computer (PC), which is not limited in embodiments of this application. In some embodiments, the terminal device 10 includes a client of an application. The application may be an application that needs to be downloaded for installation, or may be a tap-to-use application, which is not limited in embodiments of this application.

In this embodiment of this application, the foregoing application is any application that can control a virtual vehicle to move in a virtual environment. For example, the application may be a racing game, a multiplayer online battle arena (MOBA) game, a third-personal shooting game (TPS), a first-person shooting game (FPS), a multiplayer gun shooting survival game, an augmented reality (AR) application, a three-dimensional map program, a social application, and an interactive entertainment application. In addition, for different applications, forms of virtual vehicles provided by the applications may also be different, and can be pre-configured based on actual needs, which are not limited in embodiments of this application. Certainly, in an exemplary embodiment, the same application may alternatively provide a user with a plurality of virtual vehicles having different forms, which are not limited in embodiments of this application.

The foregoing virtual vehicle is a virtual article in the application that can be controlled by a user to move. The virtual vehicle may be presented in a three-dimensional form, a two-dimensional form, or a two-and-a-half dimensional form, which is not limited in embodiments of this application. In some embodiments, the virtual vehicle may also be referred to as a virtual vehicle. For example, in a racing game, a virtual vehicle is a vehicle controlled by a user during racing. In a shooting game, a virtual vehicle may be a virtual vehicle that can be found by a user in a virtual environment. In a MOBA game, a virtual vehicle may be a virtual vehicle that is summoned by controlling a virtual character by a user. This is not limited in embodiments of this application.

The server 20 is configured to provide a background service for the terminal device 10. The server 20 may be one server, a server cluster including a plurality of servers, or a cloud computing service center. In some embodiments, the server 20 may be a backend server of the client of the foregoing application. In an exemplary embodiment, the server 20 provides background services for a plurality of terminal devices 10.

Data transmission is performed between the terminal device 10 and the server 20 through a network.

In this embodiment of this application, the user may control the virtual vehicle in the foregoing application to move flexibly. For example, as shown in FIG. 2, a virtual vehicle 21 and operation controls for controlling the virtual vehicle 21 are displayed in a user interface of the terminal device 10. The operation controls include a direction adjustment control 22, a throttle control 23, a first brake control 24, and a second brake control 25.

The direction adjustment control 22 is configured to control a vehicle head orientation of the virtual vehicle 21. The user controls the vehicle head orientation of the virtual vehicle 21 by an operation on the direction adjustment control 22 for adjustment. In a possible implementation, the direction adjustment control 22 includes a plurality of sub-controls, and different sub-controls correspond to different adjustment directions. In another possible implementation, the direction adjustment control 22 includes a slider. The user adjusts the vehicle head orientation of the virtual vehicle through a slide operation on the slider, and different sliding directions correspond to different adjustment directions.

The throttle control 23 is configured to control the virtual vehicle 21 to accelerate. The user controls the virtual vehicle 21 to accelerate by an operation on the throttle control 23.

The first brake control 24 is configured to control the virtual vehicle 21 to decelerate or reverse. During the acceleration of the virtual vehicle 21, the user controls the virtual vehicle 21 to slowly decelerate by a tap/click operation on the first brake control 24. Alternatively, the user controls the virtual vehicle 21 to rapidly decelerate by a touch and hold/long press operation on the first brake control 24, and when a speed of the virtual vehicle 21 is reduced to zero, if the touch and hold/long press operation does not disappear, the user continues to control the virtual vehicle 21 to reverse.

The second brake control 25 is configured to control the virtual vehicle 21 to decelerate. The second brake control 25 is another control different from the foregoing first brake control 24. For example, the first brake control 24 may be understood as a foot brake control, and the second brake control 25 may be understood as a hand brake control. The user controls the virtual vehicle 21 to enter a drifting state by the operation on the direction adjustment control 22 and one tap/click operation on the second brake control 25, and then, controls the virtual vehicle 21 to sharply decelerate until the speed is zero by two tap/click operations on the second brake control 25.

The foregoing slow deceleration, rapid deceleration, and sharp deceleration are three different deceleration manners of the virtual vehicle. For example, deceleration efficiency of the slow deceleration is less than deceleration efficiency of the rapid deceleration, and the deceleration efficiency of the rapid deceleration is less than deceleration efficiency of the sharp deceleration.

In some embodiments, the foregoing operation controls further include a nitrogen control 26 and a reset control 27.

The nitrogen control 26 is configured to control the virtual vehicle 21 to accelerate based on accumulated nitrogen resources. The user controls, by an operation on the nitrogen control 26, the virtual vehicle 21 to consume the accumulated nitrogen resources to accelerate. In some embodiments, a nitrogen indicating icon is alternatively displayed in the user interface. The nitrogen indicating icon includes a plurality of sub-icons, and the sub-icons correspond to a first display style and a second display style. A number of nitrogen resources accumulated by the virtual vehicle 21 is in positive correlation with a number of sub-icons displayed in the first display style. During the accumulation of the nitrogen resources, the nitrogen indicating icon displays a changing process of the sub-icons changing from the second display style to the first display style, to indicate that the nitrogen resources are accumulated. During the consumption of the nitrogen resources, the nitrogen indicating icon displays a changing process of the sub-icons changing from the first display style to the second display style, to indicate that the nitrogen resources are consumed.

The reset control 27 is configured to control the virtual vehicle 21 to be out of a stuck state or an uncontrollable state. During the movement of the virtual vehicle 21, if the virtual vehicle 21 is not controllable due to the movement of the virtual vehicle 21 to a special spot, the virtual vehicle 21 is controlled, by an operation on the reset control 27, to be reset from the special spot to the nearest non-special spot, so that the virtual vehicle 21 can continue to move from the non-special spot.

The foregoing descriptions of the operation controls are exemplary and explanatory. In an exemplary embodiment, functions of the operation controls may be flexibly configured and adjusted, which are not limited in embodiments of this application. Using the foregoing first brake control as an example, during the acceleration of the virtual vehicle, the user may control the virtual vehicle to decelerate through the first brake control. In a case that the virtual vehicle is in the drifting state, the user may control, through the first brake control, the drift angle of the virtual vehicle to decrease.

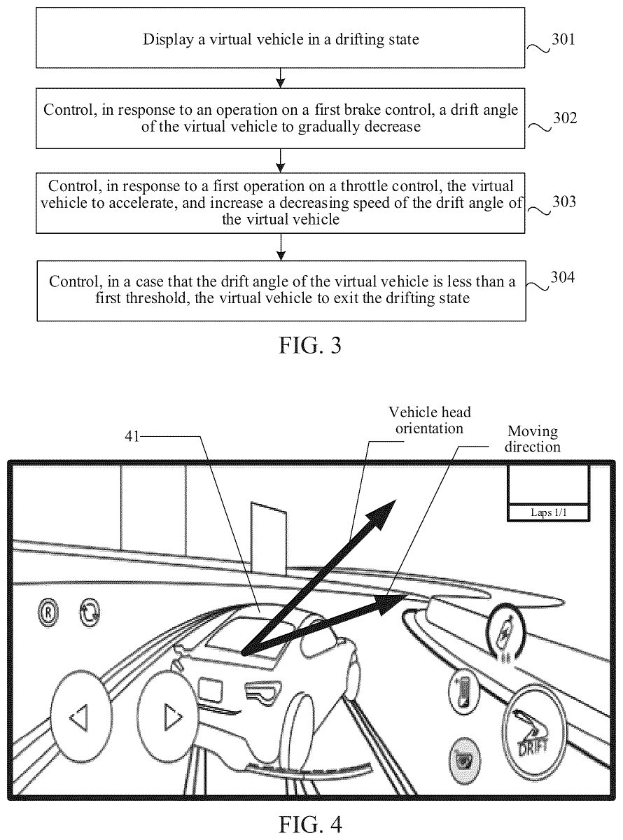

FIG. 3 is a flowchart of a virtual vehicle control method according to an embodiment of this application. The method is performed by the terminal device 10 of the virtual vehicle control system shown in FIG. 1. For example, operations may be performed by the client of the application in the terminal device 10. The method may include at least one operation in the following operations (301-304):

Operation 301: Display a virtual vehicle in a drifting state.

The drifting state is a motion state in which a moving direction of the virtual vehicle is different from a vehicle head orientation. In other words, when the virtual vehicle is in the drifting state, there is an included angle between the moving direction and the vehicle head orientation of the virtual vehicle. The vehicle head orientation is a direction directed from a vehicle tail toward a vehicle head of the virtual vehicle. For example, as shown in FIG. 4, when a virtual vehicle 41 is in a drifting state, there is an included angle between a vehicle head orientation and a moving direction of the virtual vehicle. In this embodiment of this application, the drifting state is a state in which a drift angle of the virtual vehicle is greater than a first threshold. The drift angle is the included angle between the moving direction of the virtual vehicle and the vehicle head orientation of the virtual vehicle.

In some embodiments, the first threshold may be any numerical value, such as 0°, 10°, 13°, or 15°, and the first threshold may be flexibly set based on actual circumstances, which is not limited in embodiments of this application. In a possible implementation, to improve reality of the drifting state, the first threshold is 0°. During the movement of the virtual vehicle, if there is a drift angle of the virtual vehicle, the client determines that the virtual vehicle is in the drifting state. In other words, the client controls the drift angle of the virtual vehicle to increase from zero, so as to control the virtual vehicle to enter the drifting state. In another possible implementation, to improve a display effect of the drifting state to facilitate perception of the user that the virtual vehicle enters the drifting state, the first threshold is not 0° (in other words, the first threshold is greater than 0°). During the movement of the virtual vehicle, if the drift angle of the virtual vehicle is greater than a specific numerical value, the client determines that the virtual vehicle is in the drifting state. In other words, the client controls the drift angle of the virtual vehicle to increase to a specific numerical value, so as to control the virtual vehicle to enter the drifting state.

In this embodiment of this application, the virtual vehicle is displayed on the client, and after the virtual vehicle enters the drifting state, the virtual vehicle in the drifting state is displayed on the client. In some embodiments, the virtual vehicle corresponds to a representation orientation and a logical orientation. The representation orientation corresponds to the foregoing vehicle head orientation and is configured for showing control expectation of the user for the virtual vehicle. The logical orientation corresponds to the foregoing moving direction and is configured for representing actual feedback intended by a physical system of the virtual vehicle for controlling. In this embodiment of this application, the client controls the vehicle head orientation of the virtual vehicle through the representation orientation and controls the moving direction of the virtual vehicle through the logical orientation.

In a possible implementation, there is a computation rule between the logical orientation and the representation orientation. In some embodiments, the client determines the representation orientation of the virtual vehicle based on an operation on a direction adjustment control by the user, to obtain a computation parameter and the computation rule, so as to determine the logical orientation of the virtual vehicle based on the representation orientation. Further, in a current image frame, the vehicle head orientation of the virtual vehicle is controlled based on the representation orientation, and the moving direction of the virtual vehicle is controlled based on the logical orientation.

In another possible implementation, the logical orientation is a delayed reaction of the representation orientation. In some embodiments, the client determines the representation orientation of the virtual vehicle based on an operation on the direction adjustment control by the user, and determines a historical representation orientation of the virtual vehicle as the logical orientation of the virtual vehicle. Further, in a current image frame, the vehicle head orientation of the virtual vehicle is controlled based on the representation orientation, and the moving direction of the virtual vehicle is controlled based on the logical orientation. The historical representation orientation is a representation orientation of the virtual vehicle in a previous image frame.

Operation 302: Control, in response to an operation on a first brake control, the drift angle of the virtual vehicle to gradually decrease.

In some embodiments, the first brake control is displayed on the client. The first brake control is configured to control the virtual vehicle to decelerate or reverse.

In this embodiment of this application, after displaying the first brake control, the client detects the first brake control, and when the operation on the first brake control is detected, controls the drift angle of the virtual vehicle to gradually decrease. For example, the foregoing operation on the first brake control is a tap/click operation, and the tap/click operation is an instant touch operation or an instant press operation on an action point. If it is detected that a touch operation or a press operation on an action point appears and then disappears immediately, the client determines that a tap/click operation on the action point is detected. In this embodiment of this application, the action point may be any point within a trigger region of the first brake control. In some embodiments, after detecting a touch operation or a press operation on an action point, if it is detected that the touch operation or the press operation disappears soon (for example, the operation disappears within a first duration threshold), the client determines that a tap/click operation on the action point is detected. In some embodiments, the first duration threshold may be 0.3 s, 0.5 s, 0.7 s, or the like, and a specific value of the first duration threshold may be set by a person skilled in the art based on actual circumstances, which is not specifically limited in embodiments of this application. Certainly, in an exemplary embodiment, the foregoing operation on the first brake control may be flexibly configured and adjusted based on actual circumstances, for example, a slide operation, a drag operation, or a press operation on a corresponding key, which is not limited in embodiments of this application.

In some embodiments, the client controls the drift angle of the virtual vehicle to decrease by increasing grip of the virtual vehicle. The grip represents resistance between the virtual vehicle and the ground. The grip is in negative correlation with the drift angle. To be specific, a larger drift angle indicates smaller grip, and a smaller drift angle indicates larger grip. In some embodiments, in the drifting state, the drift angle of the virtual vehicle increases, and the grip of the virtual vehicle decreases. In this case, the resistance between the virtual vehicle and the ground is small, and the virtual vehicle slips, so that the drift angle of the virtual vehicle further increases, and the grip further decreases. Afterwards, when the operation on the first brake control is detected, the virtual vehicle starts to prepare to exit the drifting state, and the grip of the virtual vehicle increases. In this case, the resistance between the virtual vehicle and the ground increases, the slip of the virtual vehicle reduces, and the drift angle of the virtual vehicle decreases, so that the grip of the virtual vehicle further increases. In some embodiments, the grip may be a frictional force between the virtual vehicle and the ground or a force that is in positive correlation with the frictional force. In this embodiment, because the grip is in positive correlation with a decreasing speed of the drift angle, a rapid decrease of the drift angle of the virtual vehicle can be achieved by increasing the grip, so that duration required to exit the drifting state is reduced.

In this embodiment of this application, when the operation on the first brake control is detected, the client controls the drift angle of the virtual vehicle to gradually decrease, and controls the virtual vehicle to decelerate movement. In some embodiments, the client controls the virtual vehicle to decelerate based on a second base acceleration while controlling the drift angle of the virtual vehicle to decrease. The second base acceleration is an acceleration corresponding to the foregoing operation on the first brake control.

Operation 303: Control, in response to a first operation on a throttle control, the virtual vehicle to accelerate, and increase the decreasing speed of the drift angle of the virtual vehicle.

In some embodiments, the throttle control is displayed on the client. The throttle control is configured to control the virtual vehicle to accelerate.

In this embodiment of this application, after displaying the throttle control, the client detects the throttle control, and when the first operation on the throttle control is detected, controls the virtual vehicle to accelerate and increases the decreasing speed of the drift angle of the virtual vehicle. For example, the foregoing first operation on the throttle control is a tap/click operation, and the tap/click operation is an instant touch/press operation for any action point in a trigger region of the throttle control. Certainly, in an exemplary embodiment, the foregoing first operation on the throttle control may be flexibly configured and adjusted based on actual circumstances, for example, a slide operation, a drag operation, or a press operation on a corresponding key, which is not limited in embodiments of this application.

In some embodiments, the client increases the decreasing speed of the drift angle of the virtual vehicle by increasing grip of the virtual vehicle. The grip is in positive correlation with the decreasing speed of the drift angle. To be specific, greater grip indicates a greater decreasing speed of the drift angle, and smaller grip indicates a smaller decreasing speed of the drift angle. For example, when the first operation on the throttle operation control is detected, the grip of the virtual vehicle is increased based on the current grip of the virtual vehicle. In this case, the resistance between the virtual vehicle and the ground further increases based on original resistance, so that the decreasing speed of the drift angle of the virtual vehicle increases.

In some embodiments, when the operation on the throttle control is detected, the client superimposes an additional first acceleration on a first base acceleration of the virtual vehicle, to obtain a first target acceleration of the virtual vehicle, and controls the virtual vehicle to accelerate based on the first target acceleration. The first base acceleration is an acceleration corresponding to the foregoing first operation on the throttle control. In this embodiment, the first acceleration is superimposed through the throttle control, so that an acceleration manner of the virtual vehicle is more similar to an acceleration manner in real life, to improve reality of a process of controlling the virtual vehicle. In this way, the user can be familiar with a manner for controlling the virtual vehicle, time and efforts of the user to learn operations for controlling the virtual vehicle can be reduced, and control experience of the user can be improved.

Operation 304: Control, when the drift angle of the virtual vehicle is less than the first threshold, the virtual vehicle to exit the drifting state.

In this embodiment of this application, during gradually decreasing of the drift angle, the client detects the drift angle, and when the drift angle of the virtual vehicle is less than the first threshold, the client controls the virtual vehicle to exit the drifting state. In a possible implementation, the first threshold is 0°. In a case that it is determined that there is no included angle between the vehicle head orientation and the moving direction of the virtual vehicle, the client controls the virtual vehicle to exit the drifting state. In another possible implementation, the first threshold is not 0°. In a case that it determines that the included angle between the vehicle head orientation and the moving direction of the virtual vehicle is less than a specific numerical value, the client controls the virtual vehicle to exit the drifting state, to avoid delays in changing from being in the drifting state to exiting the drifting state.

In some embodiments, after exiting the drifting state, the virtual vehicle enters a forward driving state. The forward driving state is a state in which the virtual vehicle is not airborne, not drifting, and traveling forward (for example, accelerating, traveling at a constant speed, decelerating) without using nitrogen resources. In some embodiments, the virtual vehicle is not airborne is a state in which tires of the virtual vehicle are both grounded. If one or more tires of the virtual vehicle are not grounded, the virtual vehicle may be considered to be in a non-forward driving state.

In this embodiment of this application, a process of the drift angle decreasing may also be referred to as a drifting-exit process (that is, a process of exiting the drifting). For the virtual vehicle in the drifting state, when the operation on the first brake control is detected, the client determines that a drifting-exit process starts; when the first operation on the throttle control is detected, the client determines to rapidly exit the drifting; and when the drift angle is less than or equal to the first threshold, the client determines that the drifting-exit process ends.

In conclusion, in the technical solutions provided in embodiments of this application, a drift angle of a virtual vehicle is controlled, through a first brake control, to be decreased, and when the drift angle of the virtual vehicle is decreased to less than or equal to a threshold, in other words, the virtual vehicle is controlled to exit a drifting state, automation of exiting from the drifting state can be implemented, without requiring a user to frequently adjust a moving direction or a vehicle head orientation of the virtual vehicle through a direction adjustment control, thereby simplifying user operation. Increasing a decreasing speed of the drift angle of the virtual vehicle through the throttle control speeds up the exit of the virtual vehicle from the drifting state, and improve drifting-exit efficiency of the virtual vehicle. In addition, controlling the virtual vehicle through the throttle control to accelerate provides a moving manner of drifting and acceleration, so that moving manners of the virtual vehicle is enriched.

In addition, grip is associated with the decreasing speed of the drift angle, and the decreasing speed of the drift angle is increased by increasing the grip. Compared with automatically playing animations, controlling the virtual vehicle by using specific parameters makes movement of the virtual vehicle during the drifting-exit more realistic.

In addition, an additional first acceleration is superimposed on a first base acceleration corresponding to a first operation on the throttle control to control the virtual vehicle to accelerate. The virtual vehicle is controlled by using specific parameters, so that the movement of the virtual vehicle during the drifting-exit is more realistic. In addition, in a manner of superimposing an acceleration, before the virtual vehicle exits the drifting state, a moving manner of accelerating and drifting, to enrich the moving manner of the virtual vehicle.

A decreasing manner of the foregoing drift angle is described below.

In an exemplary embodiment, the foregoing operation 302 includes at least one of the following operations:

1. Obtain a target vehicle head orientation of the virtual vehicle at a next timestamp.

The timestamp is configured for indicating a display moment of an image frame. In some embodiments, a previous timestamp is configured for indicating a display moment of a previous image frame, a current timestamp is configured for indicating a display moment of a current image frame, and a next timestamp is configured for indicating a display moment of a next image frame. A time interval between two adjacent timestamps is a unit time. The unit time is a time interval between two adjacent image frames. For example, the unit time may be any numerical value, such as 0.025s, 0.033s, and 0.050s, and the unit time may be flexibly set and adjusted based on actual circumstances, which is not limited in embodiments of this application.

In this embodiment of this application, when controlling the drift angle of the virtual vehicle to gradually decrease, the client obtains the target vehicle head orientation of the virtual vehicle at the next timestamp. In some embodiments, the client may determine the target vehicle head orientation based on the operation on the direction adjustment control, or may determine the vehicle head orientation of the virtual vehicle based on a historical vehicle head orientation of the virtual vehicle. The historical vehicle head orientation is a vehicle head orientation of the virtual vehicle at the current timestamp.

In a possible implementation, the client determines the target vehicle head orientation based on the operation on the direction adjustment control. In some embodiments, during the decreasing of the drift angle, when the operation on the direction adjustment control is detected, the client determines the target vehicle head orientation based on the operation on the direction adjustment control. Alternatively, when no operation on the direction adjustment control is detected, the client determines the target vehicle head orientation based on a most recently detected operation on the direction adjustment control.

In another possible implementation, the client determines the vehicle head orientation of the virtual vehicle based on the historical vehicle head orientation of the virtual vehicle. In some embodiments, during the decreasing of the drift angle, the client obtains the vehicle head orientation of the virtual vehicle at the current timestamp as the foregoing target vehicle head orientation.

The foregoing descriptions of the manner for obtaining the target vehicle head orientation are merely exemplary and explanatory, and in an exemplary embodiment, the manner for obtaining the target vehicle head orientation may be flexibly configured and adjusted based on actual circumstances, which is not limited in embodiments of this application. For example, during the decreasing of the drift angle, a user may adjust the vehicle head orientation of the virtual vehicle through the direction adjustment control. In a case that the operation on the direction adjustment control is detected, the client determines the target vehicle head orientation of the virtual vehicle at the next timestamp based on the operation. In a case that no operation on the direction adjustment control is detected, the client determines the vehicle head orientation of the virtual vehicle at the current timestamp as the foregoing target vehicle head orientation.

2. Determining a target moving direction of the virtual vehicle at the next timestamp based on the target vehicle head orientation.

In this embodiment of this application, the target vehicle head orientation is associated with the target moving direction. After determining the foregoing target vehicle head orientation, the client determines the target moving direction of the virtual vehicle at the next timestamp based on the target vehicle head orientation. In this embodiment of this application, an included angle between the target moving direction and the target vehicle head orientation is smaller than an included angle between a moving direction and the vehicle head orientation at the current timestamp.

In some embodiments, when obtaining the foregoing target moving direction, the client determines an angle change amount of the moving direction based on grip and the moving direction of the virtual vehicle at the current timestamp and the target vehicle head orientation. The grip is in positive correlation with an angle change amount of the moving direction per unit time. Afterwards, the client determines the target moving direction of the virtual vehicle at the next timestamp based on the moving direction at the current timestamp and the angle change amount of the moving direction.

3. Controlling the virtual vehicle to move at the next timestamp based on the target moving direction.

In this embodiment of this application, after determining the foregoing target vehicle head orientation and the foregoing target moving direction, the client controls the virtual vehicle to move at the next timestamp based on the target moving direction, and a vehicle head orientation displayed by the virtual vehicle is the target vehicle head orientation.

In conclusion, in the technical solutions provided in embodiments of this application, a target moving direction is determined based on a target vehicle head orientation, and a vehicle head orientation is associated with a moving direction, so that there is no need for a user to control the moving direction while controlling the vehicle head orientation, thereby simplifying operations by the user on a virtual vehicle and improving efficiency of controlling the virtual vehicle by the user. In addition, based on grip and a moving direction of the virtual vehicle at a current timestamp and a target vehicle head orientation of the virtual vehicle at a next timestamp, an angle change amount of the moving direction is determined, and then the target moving direction is determined. In this way, frame-by-frame change of the virtual vehicle is realized, and a change of a subsequent image frame depends on parameters in a current image frame, so that a change of the virtual vehicle is more realistic and coherent.

The foregoing change manner of the drift angle in the foregoing operation 302 is also applicable to the change manner of the drift angle in operation 303.

For example, it is assumed that the vehicle head orientation of the virtual vehicle is d(t), the moving direction is v(t), the grip is Fz, and the unit time is Δt. An iterative formula of the target moving direction of the virtual vehicle is as follows:

$$\begin{matrix}v ( t + Δ t ) = Fz * ( d ( t + Δ t ) - v ( t ) ) + v ( t ) ; \\ v ( t + 2 * Δ t ) = Fz * ( d ( t + 2 * Δ t ) - v ( t + Δ t ) ) + v ( t + Δ t ) ; \\ … \\ v ( t + n * Δ t ) = Fz * [ d ( t + n * Δ t ) - v ( t + ( n - 1 ) * Δ t ) ] + v ( t + ( n - 1 ) * Δ t ) ;\end{matrix}$$

The grip is in negative correlation with the drift angle. In a case that the operation on the first brake control is detected, the client increases the grip of the virtual vehicle. It can be learned from the foregoing interactive formula that, in this process, the moving direction of the virtual vehicle is gradually approaches the vehicle head orientation, and the drift angle of the virtual vehicle gradually decreases. Further, when the operation on the throttle control is detected, the grip of the virtual vehicle continues to increase based on the original grip. It can be learned from the foregoing interactive formula that, in this process, the moving direction of the virtual vehicle rapidly approaches the vehicle head orientation, and the drift angle of the virtual vehicle rapidly decreases.

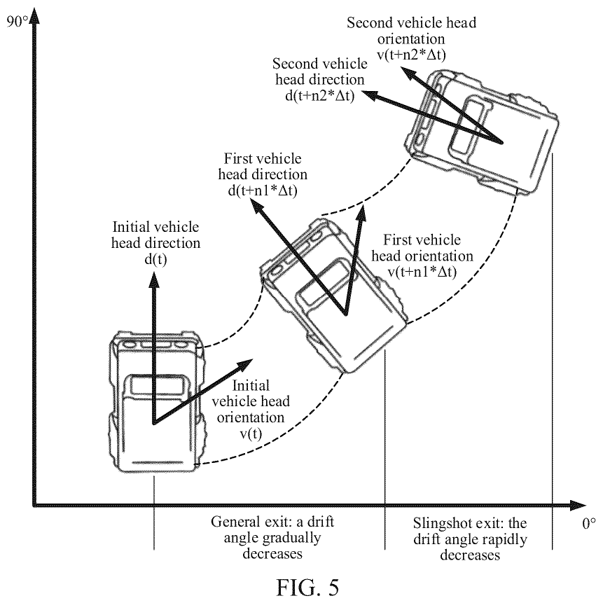

For example, with reference to FIG. 5, an example in which an initial vehicle head direction of the virtual vehicle is 90° is used as an example. In a case that the operation on the first brake control is detected, the client controls the drift angle of the virtual vehicle to gradually decrease, and when the operation on the throttle control is detected, the client controls the drift angle of the virtual vehicle to rapidly decrease.

In some embodiments, after exiting the drifting state, the virtual vehicle keeps accelerating. An acceleration mode after the virtual vehicle exits the drifting state is described below.

In a possible implementation, after the foregoing operation 304, the method further includes the following sub-operations: controlling the virtual vehicle to accelerate within first duration from an exit moment of the drifting state.

In this embodiment of this application, after determining that the virtual vehicle exits the drifting state, the client controls the virtual vehicle to accelerate within the first duration from the exit moment of the drifting state.

In some embodiments, when controlling the virtual vehicle to accelerate, the client superimposes an additional second acceleration on the first base acceleration of the virtual vehicle, to obtain a second target acceleration of the virtual vehicle, and controls the virtual vehicle to accelerate based on the second target acceleration within the first duration from the exit moment of the drifting state. In this embodiment, the virtual vehicle is controlled through acceleration superimposition to accelerate, and because the first base acceleration is generally different in different cases, the second target acceleration on which the same second acceleration is superimposed is also different each time. In this way, an inflexible acceleration mode with the same acceleration from case to case can be avoided, and acceleration diversity of the virtual vehicle after exiting the drifting is improved, thereby improving user experience. The foregoing second acceleration may be the same as or different from the foregoing first acceleration, which is not limited in embodiments of this application. The foregoing first duration may be any duration, such as 0.2s, 0.3s, or 0.4s, and the first duration may be flexibly set and adjusted based on actual circumstances, which is not limited in embodiments of this application.

In some embodiments, after the first duration, the client controls the virtual vehicle to accelerate based on the first base acceleration.

In conclusion, in the technical solutions provided in embodiments of this application, the virtual vehicle is automatically controlled to accelerate after the drifting ends, and user operation is simplified.

In another possible implementation, after the foregoing operation 304, the method further includes at least one of the following sub-operations:

1. Control, when a second operation on the throttle control is detected, the virtual vehicle to accelerate within duration of the second operation.

In this embodiment of this application, after determining that the virtual vehicle exits the drifting state, the client detects the throttle control, and when the second operation on the throttle control is detected, the client controls the virtual vehicle to accelerate within the duration of the second operation. For example, the foregoing second operation on the throttle control is a touch and hold/long press operation, and the touch and hold/long press operation is an operation in which duration of touching and holding/long pressing a specific action point exceeds a second duration threshold. If it is detected that there is a touch/press operation on a specific action point occurs and the operation lasts for a period of time then disappears, the client determines a touch and hold/long press operation on the action point is detected. In this embodiment of this application, the action point may be any point within the trigger region of the throttle operation control. In some embodiments, the second duration threshold may be 0.5 s, 0.7 s, Is, 1.5s, 2s, or the like, and a specific value of the second duration threshold may be set by a person skilled in the art based on actual circumstances, which is not specifically limited in embodiments of this application.

In some embodiments, when controlling the virtual vehicle to accelerate, the client superimposes an additional third acceleration on the first base acceleration of the virtual vehicle, to obtain a third target acceleration of the virtual vehicle, and controls the virtual vehicle to accelerate based on the third target acceleration within the duration of the second operation. The foregoing third acceleration may be the same as or different from the foregoing second acceleration, which is not limited in embodiments of this application.

In this embodiment of this application, a detection moment of the second operation is a moment at which the virtual vehicle exits the drifting state. However, a trigger moment of the second operation by the user may be any moment between a moment at which it is determined that the drift angle rapidly decreases and a moment at which it is determined that the virtual vehicle exits the drifting state, which is not limited in embodiments of this application.

2. Display first prompt information if the duration of the second operation reaches a maximum response value from an exit moment of the drifting state.

In this embodiment of this application, after the foregoing second operation is detected, the client times the duration of the second operation, and displays the first prompt information if the duration of the second operation reaches the maximum response value (for example, the foregoing second duration threshold) from the exit moment of the drifting state. The first prompt information is prompt information configured for indicating that a full throttle skill is triggered. For example, the first prompt information may alternatively be understood to be configured for indicating that the duration of the second operation reaches the foregoing maximum response value. In some embodiments, the full throttle skill being triggered indicates that after the duration of the second operation on a throttle reaches the maximum response value, an acceleration effect of accelerating the vehicle through the throttle control is maximized, and the virtual vehicle cannot accelerate any further.

The maximum response value is maximum response duration of the second operation from the exit moment of the drifting state. In a case that the duration of the second operation reaches the maximum response value, the client does not respond to the second operation even though the user continues to trigger the second operation. In some embodiments, after the duration of the second operation reaches the maximum response value, the client controls the virtual vehicle to accelerate based on the first base acceleration.

In conclusion, in the technical solutions provided in embodiments of this application, acceleration duration of the virtual vehicle is determined based on the duration of the second operation, and the user can select the acceleration duration of the virtual vehicle based on actual circumstances, so that flexibility of user operation can be improved. After the duration of the second operation reaches the maximum response value, the first prompt information is displayed to indicate that the duration of the second operation reaches the maximum response value, to avoid the user continue to trigger the second operation in a non-response period.

In still another possible implementation, after the foregoing operation 304, the method further includes at least one of the following sub-operations:

1. Control the virtual vehicle to accelerate within first duration from an exit moment of the drifting state.

2. Continue to control, when a second operation on the throttle control is detected, the virtual vehicle to accelerate within duration of the second operation from an end moment of the first duration.

A detection moment of the second operation is the end moment of the first duration, and a trigger moment of the second operation by the user may be any moment between a moment at which it is determined that the drift angle rapidly decreases and the end moment of the first duration, which are not limited in embodiments of this application.

3. Display first prompt information if the duration of the second operation reaches a maximum response value from the end moment of the first duration.

In conclusion, in the technical solutions provided in embodiments of this application, a virtual vehicle is automatically controlled to accelerate after the end of drifting, and acceleration duration of the virtual vehicle is extended based on duration of the second operation, to provide a user with a way of flexibly selecting the acceleration duration while simplifying user operation.

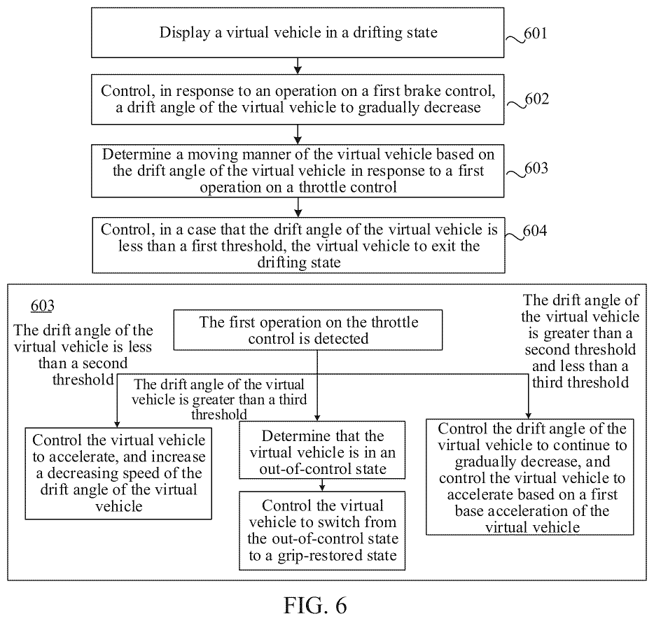

FIG. 6 is a flowchart of a virtual vehicle control method according to another embodiment of this application. The method is performed by the terminal device 10 of the virtual vehicle control system shown in FIG. 1. For example, operations may be performed by the client of the application in the terminal device 10. The method may include at least one operation in the following operations (601-604):

Operation 601: Display a virtual vehicle in a drifting state.

Operation 602: Control, in response to an operation on a first brake control, a drift angle of the virtual vehicle to gradually decrease.

The foregoing operation 601 and operation 602 are similar to 301 and 302 in the embodiment of FIG. 3. For details, reference is made to the embodiment of FIG. 3. Details are not described herein.

Operation 603: Determine a moving manner of the virtual vehicle based on the drift angle of the virtual vehicle in response to a first operation on a throttle control.

In some embodiments, when the first operation on the throttle control is detected, if the drift angle of the virtual vehicle is less than a second threshold, the client controls the virtual vehicle to accelerate, and increases a decreasing speed of the drift angle of the virtual vehicle. In addition, second prompt information is displayed, and the second prompt information is prompt information configured for indicating that slingshot exit skill is triggered. For example, the second prompt information may alternatively be understood to be configured for indicating that the virtual vehicle enters a target drifting-exit state. The target drifting-exit state is a moving manner in which the virtual vehicle accelerates and the decreasing speed of the drift angle increases. For example, the target drifting-exit state may also be referred to as a fast drifting-exit state, a rapid drifting-exit state, a slingshot exit state, or an accelerated exit state. In this embodiment, displaying the prompt information allows a user to timely knows that the slingshot exit skill of the virtual vehicle is triggered and a subsequent operation is possible, so that user operation efficiency can be improved.

In some embodiments, when the first operation on the throttle control is detected, if the drift angle of the virtual vehicle is greater than a third threshold, the client determines that the virtual vehicle is in an out-of-control state. In the out-of-control state, grip of the virtual vehicle is close to zero. It can be learned from the foregoing iterative formula that when the grip of the virtual vehicle is close to zero, a moving direction of the virtual vehicle is unadjustable. In this case, the client needs to control the virtual vehicle to switch from the out-of-control state to a grip-restored state. In some embodiments, the client controls the virtual vehicle to exit the out-of-control state by controlling the grip of the virtual vehicle to increase. In addition, when the first operation on the throttle control is detected and the drift angle of the virtual vehicle is greater than the third threshold, the client displays third prompt information, and the third prompt information is prompt information configured for indicating that a grip-restored skill is triggered. For example, the third prompt information may alternatively be understood to be configured for indicating that the virtual vehicle enters the grip-restored state. In this embodiment, the virtual vehicle in the out-of-control state can be restored to the controllable grip-restored state by the first operation on the throttle, to minimize duration in which the virtual vehicle is in the out-of-control state as much as possible and maintain a sense of control of the user and experience of controlling the virtual vehicle. In addition, the prompt information prompts the user that the grip has been restored, to prevent the user from continuing to perform an operation for restoring the grip, thereby reducing unnecessary operations and improving operating efficiency of the user.

In some embodiments, restoring a grip state indicates that the grip of the virtual vehicle is restored, so that the virtual vehicle exits the out-of-control state to restore a controllable state.

In some embodiments, the grip of the virtual vehicle being close to zero indicates that the grip of the virtual vehicle is less than or equal to a fourth threshold, and a specific value of the fourth threshold may be set by a person skilled in the art based on actual circumstances, which is not specifically limited in embodiments of this application.

In some embodiments, when the first operation on the throttle control is detected, if the drift angle of the virtual vehicle is greater than the second threshold and less than the third threshold, the client controls the drift angle of the virtual vehicle to continue to gradually decrease, and controls the virtual vehicle to accelerate based on a first base acceleration of the virtual vehicle.

Indeed, the second threshold and the third threshold may be any numerical value. For example, the second threshold may be 40°, 45°, 50°, or the like, and the third threshold may be 65°, 67°, 80°, or the like. The second threshold and the third threshold may be set by a person skilled in the art based on actual circumstances, which is not limited in embodiments of this application. The second threshold is less than the third threshold.

Operation 604: Control, when the drift angle of the virtual vehicle is less than a first threshold, the virtual vehicle to exit the drifting state.

The foregoing operation 604 is similar to 304 in the embodiment of FIG. 3. For details, reference is made to the embodiment of FIG. 3. Details are not described herein.

In conclusion, in the technical solutions provided in embodiments of this application, combining a first brake control and a throttle control provides different moving manners for a virtual vehicle with different drift angles during drifting of the virtual vehicle, and the moving manner of the virtual vehicle is enriched. In addition, when the drift angle of the virtual vehicle is large, the virtual vehicle is controlled through the first brake control and the throttle control to restore from an out-of-control state to a grip-restored state; when the drift angle of the virtual vehicle is small, the virtual vehicle is controlled through the first brake control and the throttle control to rapidly exit the drifting; and when the drift angle of the virtual vehicle is intermediate, the drift angle is stably maintained to decrease. In this way, configuring different drift angles allows movement of the virtual vehicle to be more realistic, so that immersive experience can be provided to the user.

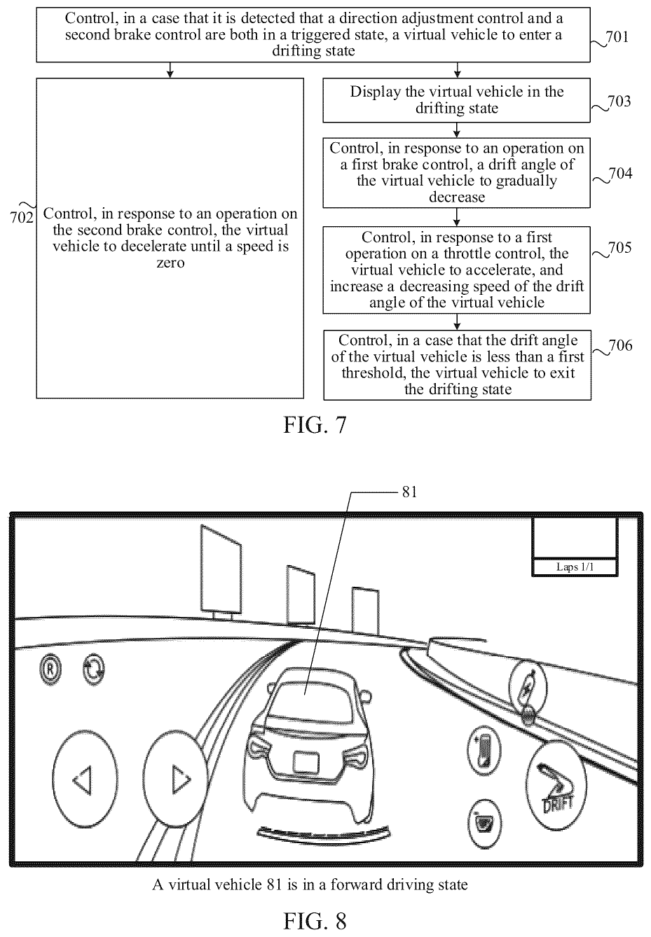

FIG. 7 is a flowchart of a virtual vehicle control method according to another embodiment of this application. The method is performed by the terminal device 10 of the virtual vehicle control system shown in FIG. 1. For example, operations may be performed by the client of the application in the terminal device 10. The method may include at least one operation in the following operations (701-706):

Operation 701: Control, when it is detected that a direction adjustment control and a second brake control are both in a triggered state, a virtual vehicle to enter a drifting state.

In some embodiments, the direction adjustment control is displayed on the client, and the direction adjustment control is configured to adjust a vehicle head orientation of the virtual vehicle.

In a possible implementation, the direction adjustment control includes a plurality of sub-controls, and different sub-controls correspond to different adjustment directions. In some embodiments, a user controls different adjustment directions through different sub-controls. In a case that an operation on a target sub-control is detected, the client controls, based on attribute information of the operation, a vehicle head of the virtual vehicle to be adjusted toward a direction indicated by the target sub-control. For example, the attribute information includes a number of taps/clicks, and the number of taps/clicks is in positive correlation with orientation adjustment magnitude. To be specific, a greater number of taps/clicks indicates larger orientation adjustment magnitude, and a smaller number of taps/clicks indicates smaller orientation adjustment magnitude. Alternatively, the attribute information includes touch/press duration, and the touch/press duration is in positive correlation with orientation adjustment magnitude. To be specific, longer touch/press duration indicates larger orientation adjustment magnitude, and shorter touch/press duration indicates smaller orientation adjustment magnitude.

In another possible implementation, the direction adjustment control includes a slider. The user adjusts the vehicle head orientation of the virtual vehicle through a slide operation on the slider, and different sliding directions correspond to different adjustment directions. In some embodiments, when the slide operation on the slider is detected, the client controls the vehicle head orientation of the virtual vehicle to be adjusted based on attribute information of the slide operation. For example, the attribute information includes a sliding direction and a sliding distance. The client determines an adjustment direction for the vehicle head orientation based on the sliding direction and determines an adjustment angle for the vehicle head orientation based on the sliding distance.

In this embodiment of this application, when it is detected that the direction adjustment control and the second brake control are both in the triggered state, the client controls the virtual vehicle to enter the drifting state. The direction adjustment control and the second brake control being both in the triggered state means that there is a specific moment at which the user triggers both the direction adjustment control and the second brake control. Whether a triggering start moment and a triggering end moment of the two operation controls are the same or different is not limited in embodiments of this application.

In this embodiment of this application, the second brake control is another control different from a first brake control. For example, the second brake control may be understood as a hand brake control, and the virtual vehicle can be controlled by the hand brake control to enter a tire locked state after decelerating to zero. The first brake control may be understood as a foot brake control, and the virtual vehicle can be controlled by the foot brake control to start reversing after decelerating to zero.

In the foregoing embodiment, when it is detected that the direction adjustment control and the second brake control are both in the triggered state, the virtual vehicle is controlled to enter the drifting state when, so that drifting of the virtual vehicle is similar to a real situation, thereby improving reality and operating experience of operating the virtual vehicle.

Operation 702: Control, in response to an operation on the second brake control, the virtual vehicle to decelerate until a speed is zero.

In this embodiment of this application, when the virtual vehicle is in the drifting state, if the operation on the second brake control is detected, the client controls the virtual vehicle to decelerate until the speed is zero. The virtual vehicle is controlled to decelerate through the brake, so that the virtual vehicle decelerates in a manner similar to a real situation, thereby improving reality of operating the virtual vehicle. In some embodiments, after the speed of the virtual vehicle decreases to zero, the virtual vehicle may enter the tire locked state, in other words, the virtual vehicle stops moving.

Operation 703: Control, when no operation on the second brake control is detected, to display the virtual vehicle in the drifting state.

Operation 704: Control, in response to an operation on the first brake control, a drift angle of the virtual vehicle to gradually decrease.

Operation 705: Control, in response to a first operation on a throttle control, the virtual vehicle to accelerate, and increase a decreasing speed of the drift angle of the virtual vehicle.

Operation 706: Control, when the drift angle of the virtual vehicle is less than a first threshold, the virtual vehicle to exit the drifting state.

The foregoing operation 703 to operation 706 are similar to operation 301 to operation 304 in the embodiment of FIG. 3. For details, reference is made to the embodiment of FIG. 3. Details are not described herein.

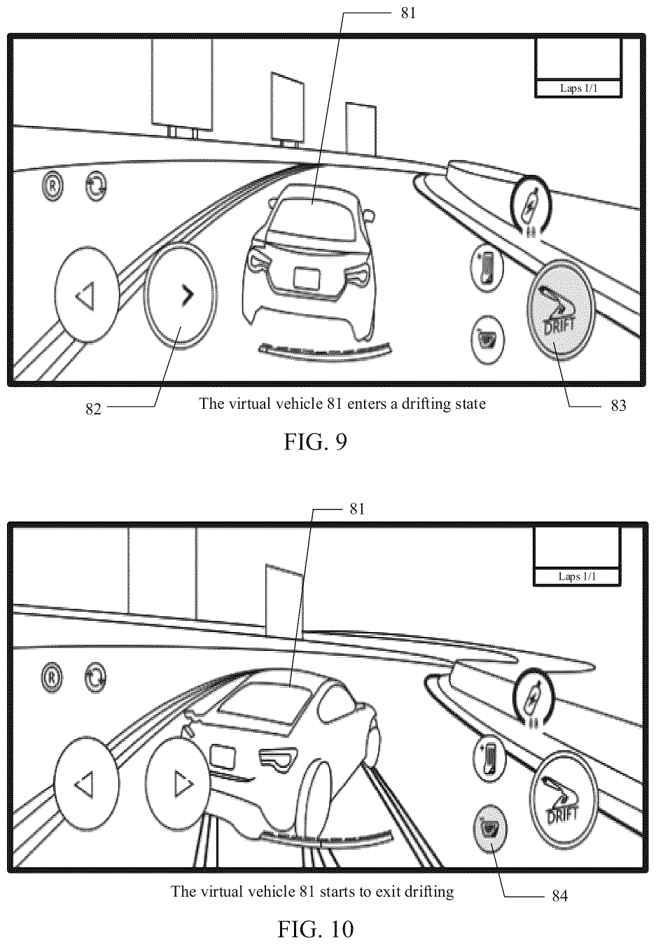

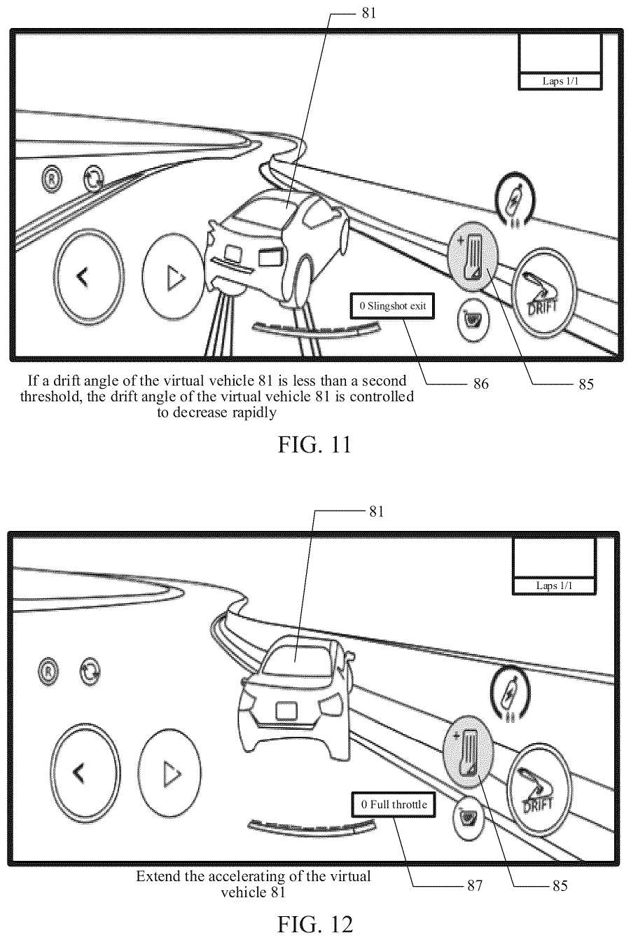

For example, moving manners of the virtual vehicle in the drifting state and after exiting the drifting state are described with reference to FIG. 8 to FIG. 12. As shown in FIG. 8, a virtual vehicle 81 is in a forward driving state. Afterwards, when it is detected that a direction adjustment control 82 and a second brake control 83 are both triggered, as shown in FIG. 9, the virtual vehicle 81 is controlled to enter a drifting state. Afterwards, as shown in FIG. 10, when the virtual vehicle 81 is in the drifting state and when an operation on the first brake control 84 is detected, a drift angle of the virtual vehicle 81 is controlled to decrease, so that the virtual vehicle 81 is controlled to start to exit drifting. Afterwards, as shown in FIG. 11, when the virtual vehicle 81 is in the drifting state and when a tap/click operation on a throttle control 85 is detected, if the drift angle of the virtual vehicle 81 is less than a second threshold, the drift angle of the virtual vehicle 81 is controlled to rapidly decrease, and the virtual vehicle 81 is controlled to accelerate. In addition, second prompt information 86 is displayed to indicate the virtual vehicle 81 enter a slingshot exit state. Afterwards, when the drift angle of the virtual vehicle 81 is less than a first threshold, the virtual vehicle 81 exits the drifting state to re-enter the forward driving state, and the virtual vehicle 81 is automatically controlled to continue to accelerate or 0.3s. Afterwards, as shown in FIG. 12, when a touch and hold/long press operation on the throttle control 85 is detected, the accelerating of the virtual vehicle 81 is extended within duration of the touch and hold/long press operation. In addition, when the duration of the touch and hold/long press operation reaches 0.5 s, first prompt information 87 is displayed to indicate that duration of a second operation reaches a maximum response value.

In conclusion, in the technical solutions provided in embodiments of this application, a virtual vehicle is controlled to enter a drifting state through a direction adjustment control cooperating with a second hand brake control. Afterwards, the virtual vehicle is controlled to stop moving through the second hand brake control again. In this way, the virtual vehicle can be controlled to enter the drifting state without needing to configure a new drifting control, thereby improving simplicity of a user interface.

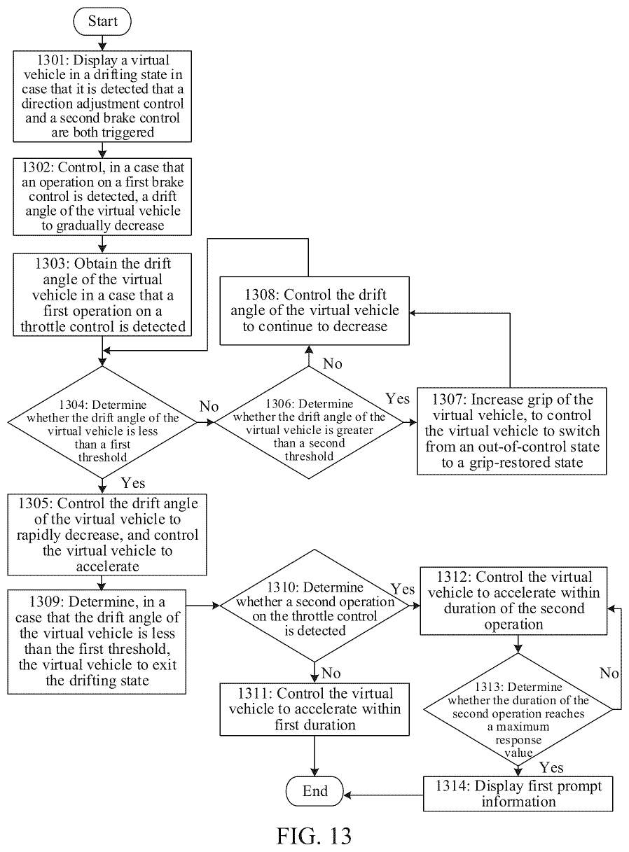

In addition, a moving process of the virtual vehicle from the drifting state to exiting the drifting state is described with reference to FIG. 13. Specific operations are as follows:

Operation 1301: Display a virtual vehicle in a drifting state in case that it is detected that a direction adjustment control and a second brake control are both triggered.

Operation 1302: Control, when an operation on a first brake control is detected, a drift angle of the virtual vehicle to gradually decrease.

Operation 1303: Obtain the drift angle of the virtual vehicle when a first operation on a throttle control is detected.

Operation 1304: Determine whether the drift angle of the virtual vehicle is less than a first threshold. If the drift angle of the virtual vehicle is less than the first threshold, operation 1305 is performed. If the drift angle of the virtual vehicle is not less than the first threshold, operation 1306 is performed.

Operation 1305: Control the drift angle of the virtual vehicle to rapidly decrease, and control the virtual vehicle to accelerate.

Operation 1306: Determine whether the drift angle of the virtual vehicle is greater than a second threshold. If the drift angle of the virtual vehicle is greater than the second threshold, operation 1307 is performed. If the drift angle of the virtual vehicle is not greater than the second threshold, operation 1308 is performed.

Operation 1307: Increase grip of the virtual vehicle, to control the virtual vehicle to switch from an out-of-control state to a grip-restored state.

Operation 1308: Control the drift angle of the virtual vehicle to continue to decrease.

Operation 1309: Determine, when the drift angle of the virtual vehicle is less than the first threshold, the virtual vehicle to exit the drifting state.

Operation 1310: Determine whether a second operation on the throttle control is detected. In a case that the second operation on the throttle control is detected, operation 1312 is performed; In a case that no second operation on the throttle control is detected, operation 1311 is performed;

Operation 1311: Control the virtual vehicle to accelerate within first duration.

Operation 1312: Control the virtual vehicle to accelerate within duration of the second operation.

Operation 1313: Determine whether the duration of the second operation reaches a maximum response value. In a case that the duration of the second operation reaches the maximum response value, operation 1314 is performed. In a case that the duration of the second operation does not reach the maximum response value, operation 1312 continues to be performed.

Operation 1314: Display first prompt information.

A moving manner of the virtual vehicle in a state different from the drifting state is described below.

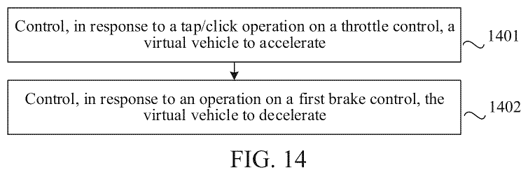

FIG. 14 is a flowchart of a virtual vehicle control method according to another embodiment of this application. The method is performed by the terminal device 10 of the virtual vehicle control system shown in FIG. 1. For example, operations may be performed by the client of the application in the terminal device 10. The method may include at least one operation in the following operations (1401-1402):

Operation 1401: Control, in response to a tap/click operation on a throttle control, a virtual vehicle to accelerate.

The throttle control is configured to control the virtual vehicle to accelerate. In this embodiment of this application, when the tap/click operation on the throttle control is detected, the client controls the virtual vehicle to accelerate. In some embodiments, the throttle control corresponds to a first base acceleration, and the clients controls the virtual vehicle to accelerate based on the first base acceleration. A direction of the first base acceleration is the same as a moving direction of the virtual vehicle.

Operation 1402: Control, in response to an operation on a first brake control, the virtual vehicle to decelerate.

The first brake control is configured to control the virtual vehicle to decelerate or reverse. In this embodiment of this application, when the operation on the first brake control is detected, the client controls the virtual vehicle to decelerate.

In a possible implementation, the foregoing operation is a tap/click operation. In a case that the tap/click operation on the first brake control is detected, the client controls the virtual vehicle to decelerate until a speed is zero. In some embodiments, the first brake control corresponds to a second base acceleration, and the clients controls the virtual vehicle to decelerate based on the second base acceleration. A direction of the second base acceleration is opposite to the moving direction of the virtual vehicle.

In another possible implementation, the foregoing operation is a touch and hold/long press operation. In this embodiment of this application, when the touch and hold/long press operation on the first brake control is detected, the client controls the virtual vehicle to decelerate. Further, when the speed of the virtual vehicle decreases to zero and the touch and hold/long press operation does not disappear, the virtual vehicle is controlled to reverse. In some embodiments, the first brake control corresponds to the second base acceleration and a fourth acceleration, and the fourth acceleration is superimposed on the second base acceleration to obtain a fourth target acceleration, so that the client controls the virtual vehicle to decelerate based on the fourth target acceleration. A direction of the fourth target acceleration is opposite to the moving direction of the virtual vehicle.

In conclusion, in the technical solutions provided in embodiments of this application, a virtual vehicle is controlled through a tap/click operation on a throttle control to accelerate, and the virtual vehicle can keep accelerating without needing to touch and hold/long press the throttle control, so that user operation is simplified, and detecting overload of a terminal device can be reduced. The virtual vehicle can be controlled through a first brake control to decelerate or reverse, so that a moving manner of the virtual vehicle can be enriched, and speed adjustment for the virtual vehicle is more flexible.

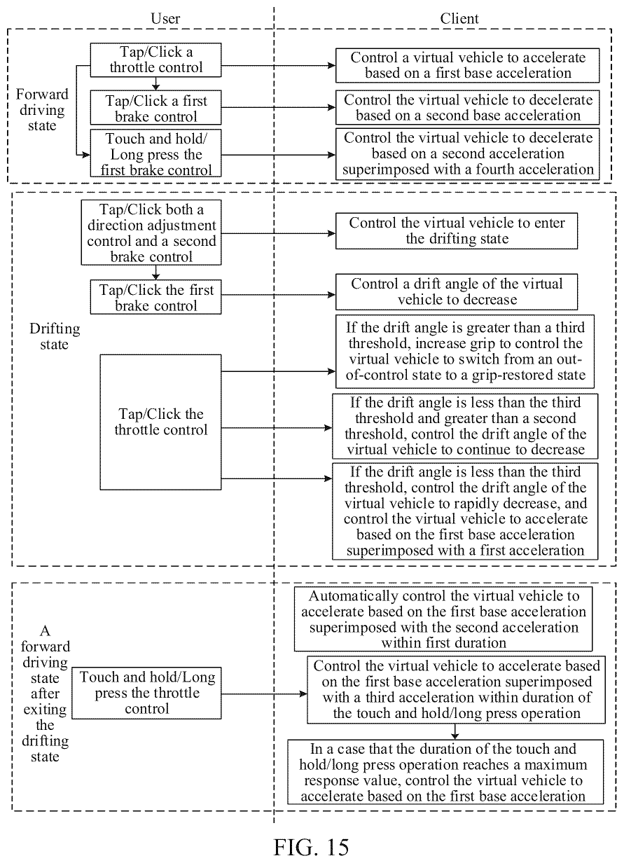

In addition, a manner for controlling a virtual vehicle is described from a human-machine interaction perspective with reference to FIG. 15. Details are provided as follows:

For a forward driving state, a user taps/clicks a throttle control, a client controls the virtual vehicle to accelerate based on a first base acceleration. The user taps/clicks a first brake control, and the client controls the virtual vehicle to decelerate based on a second base acceleration. The user touches and holds/long presses the first brake control, and the client controls the virtual vehicle to decelerate based on a second acceleration superimposed with a fourth acceleration.

For a drifting state, the user taps/clicks both a direction adjustment control and a second brake control, and the client controls the virtual vehicle to enter the drifting state. The user taps/clicks the first brake control, and the client controls a drift angle of the virtual vehicle to decrease. The user taps/clicks the throttle control. In a case that the drift angle is greater than a third threshold, the client increases grip to control the virtual vehicle to switch from an out-of-control state to a grip-restored state. In a case that the drift angle is less than the third threshold and greater than a second threshold, the client controls the drift angle of the virtual vehicle to continue to decrease. In a case that the drift angle is less than the third threshold, the client controls the drift angle of the virtual vehicle to rapidly decrease, and controls the virtual vehicle to accelerate based on the first base acceleration superimposed with a first acceleration.

For a forward driving state after the virtual vehicle exits the drifting state, the client automatically controls the virtual vehicle to accelerate based on the first base acceleration superimposed with the second acceleration within first duration. The user touches and holds/long presses the throttle control, and the client controls the virtual vehicle to accelerate based on the first base acceleration superimposed with a third acceleration within duration of the touch and hold/long press operation. Afterwards, when the duration of the touch and hold/long press operation reaches a maximum response value, the client controls the virtual vehicle to accelerate based on the first base acceleration.

In embodiments of this application, the foregoing description of “greater than” and “less than” may be incorporated into any branch. For example, “less than a first threshold” may be understood as “less than a first threshold” or “less than or equal to a first threshold”.

The foregoing descriptions of this application by way of embodiments are merely exemplary and explanatory, and new embodiments formed by any combination of the operations in the foregoing embodiments also fall within the scope of this application.

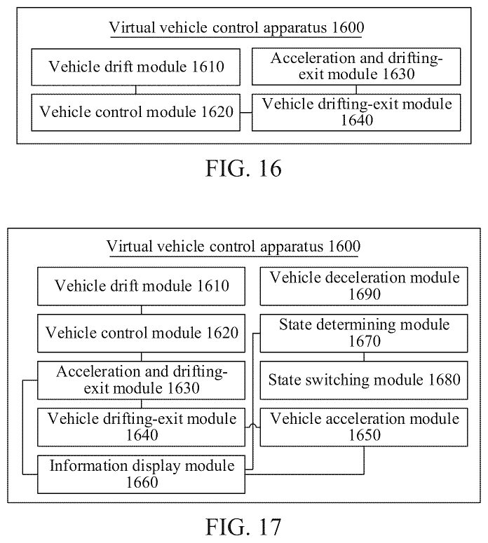

FIG. 16 is a block diagram of a virtual vehicle control apparatus according to an embodiment of this application. The apparatus has functions of implementing the foregoing virtual vehicle control method. The functions may be implemented by hardware or may be implemented by hardware executing corresponding software. The apparatus may be a terminal device or may be provided in a terminal device. The apparatus 1600 may include a vehicle drift module 1610, a vehicle control module 1620, an acceleration and drifting-exit module 1630, and a vehicle drifting-exit module 1640.

The vehicle drift module 1610 is configured to display a virtual vehicle in a drifting state. The drifting state is a state in which a drift angle of the virtual vehicle is greater than a first threshold, and the drift angle is an included angle between a moving direction of the virtual vehicle and a vehicle head orientation of the virtual vehicle.

The vehicle control module 1620 is configured to control, in response to an operation on a first brake control, the drift angle of the virtual vehicle to gradually decrease.

The acceleration and drifting-exit module 1630 is configured to: control, in response to a first operation on a throttle control, the virtual vehicle to accelerate, and increase a decreasing speed of the drift angle of the virtual vehicle.

The vehicle drifting-exit module 1640 is configured to control, when the drift angle of the virtual vehicle is less than the first threshold, the virtual vehicle to exit the drifting state.

In an exemplary embodiment, the acceleration and drifting-exit module 1630 is further configured to increase grip of the virtual vehicle. The grip is in positive correlation with the decreasing speed of the drift angle.

In an exemplary embodiment, the acceleration and drifting-exit module 1630 is further configured to:
superimpose an additional first acceleration on a first base acceleration of the virtual vehicle, to obtain a first target acceleration of the virtual vehicle; and
control the virtual vehicle to accelerate based on the first target acceleration.

In an exemplary embodiment, the vehicle control module 1620 includes an orientation obtaining unit, a movement determining unit, and a movement control unit.

The orientation obtaining unit is configured to obtain a target vehicle head orientation of the virtual vehicle at a next timestamp. A time interval between two adjacent timestamps is a unit time.

The movement determining unit is configured to determine a target moving direction of the virtual vehicle at the next timestamp based on the target vehicle head orientation. An included angle between the target moving direction and the target vehicle head orientation is smaller than an included angle between a moving direction and a vehicle head orientation at a current timestamp.

The movement control unit is configured to control the virtual vehicle to move at the next timestamp based on the target moving direction.

In an exemplary embodiment, the movement determining unit is configured to:
determine an angle change amount of the moving direction based on grip and the moving direction of the virtual vehicle at the current timestamp and the target vehicle head orientation, the grip being in positive correlation with an angle change amount of the moving direction per unit time; and
determine the target moving direction of the virtual vehicle at the next timestamp based on the moving direction at the current timestamp and the angle change amount of the moving direction.

In an exemplary embodiment, as shown in FIG. 17, the apparatus 1600 further includes a vehicle acceleration module 1650.

The vehicle acceleration module 1650 is configured to control the virtual vehicle to accelerate within first duration from an exit moment of the drifting state.

In an exemplary embodiment, as shown in FIG. 17, the vehicle acceleration module 1650 is further configured to:
superimpose an additional second acceleration on a first base acceleration of the virtual vehicle, to obtain a second target acceleration of the virtual vehicle; and
control the virtual vehicle to accelerate based on the second target acceleration within the first duration from the exit moment of the drifting state.

In an exemplary embodiment, as shown in FIG. 17, the apparatus 1600 further includes an information display module 1660.

The vehicle acceleration module 1650 is further configured to control, when a second operation on the throttle control is detected, the virtual vehicle to accelerate within duration of the second operation.

The information display module 1660 is configured to display first prompt information if the duration of the second operation reaches a maximum response value from an exit moment of the drifting state. The first prompt information is configured for indicating that the duration of the second operation reaches the maximum response value.

In an exemplary embodiment, the acceleration and drifting-exit module 1630 is further configured to perform, in response to the first operation on the throttle control and when the drift angle of the virtual vehicle is less than a second threshold, the operation of controlling the virtual vehicle to accelerate and increasing a decreasing speed of the drift angle of the virtual vehicle.

In an exemplary embodiment, as shown in FIG. 17, the information display module 1660 is further configured to display second prompt information. The second prompt information is configured for indicating that the virtual vehicle enters a target drifting-exit state.

In an exemplary embodiment, as shown in FIG. 17, the apparatus 1600 further includes a state determining module 1670 and a state switching module 1680.

The state determining module 1670 is configured to determine, in response to the first operation on the throttle control and when the drift angle of the virtual vehicle is greater than a third threshold, that the virtual vehicle is in an out-of-control state. In the out-of-control state, grip of the virtual vehicle is close to zero and the moving direction of the virtual vehicle is unadjustable.

The state switching module 1680 is configured to control the virtual vehicle to switch from the out-of-control state to a grip-restored state.

In an exemplary embodiment, the state switching module 1680 is further configured to:
control the grip of the virtual vehicle to increase, to control the virtual vehicle to exit the out-of-control state; and
display third prompt information, the third prompt information being configured for indicating that the virtual vehicle enters the grip-restored state.

In an exemplary embodiment, the vehicle control module 1620 is further configured to: control, in response to the first operation on the throttle control and when the drift angle of the virtual vehicle is greater than a second threshold and less than a third threshold, the drift angle of the virtual vehicle to continue to gradually decrease, and control the virtual vehicle to accelerate based on a first base acceleration of the virtual vehicle.

In an exemplary embodiment, as shown in FIG. 17, the vehicle drift module 1610 is further configured to control, when it is detected that a direction adjustment control and a second brake control are both in a triggered state, the virtual vehicle to enter the drifting state. The second brake control is another control different from the first brake control.

In an exemplary embodiment, as shown in FIG. 17, the apparatus 1600 further includes a vehicle deceleration module 1690.

The vehicle deceleration module 1690 is configured to control, in response to an operation on the second brake control, the virtual vehicle to decelerate until a speed is zero.

In an exemplary embodiment, the vehicle acceleration module 1650 is further configured to control, in response to a tap/click operation on the throttle control, the virtual vehicle to accelerate.

In an exemplary embodiment, the vehicle deceleration module 1690 is further configured to control, in response to the operation on the first brake control, the virtual vehicle to decelerate.

In an exemplary embodiment, the vehicle deceleration module 1690 is further configured to:
control, in response to a tap/click operation on the first brake control, the virtual vehicle to decelerate until a speed is zero; or
control, in response to a touch and hold/long press operation on the first brake control, the virtual vehicle to decelerate; and control, when a speed of the virtual vehicle is reduced to zero and the touch and hold/long press operation does not disappear, the virtual vehicle to reverse.

In conclusion, in the technical solutions provided in embodiments of this application, a drift angle of a virtual vehicle is controlled, through a first brake control, to be decreased, and when the drift angle of the virtual vehicle is decreased to less than a threshold, in other words, the virtual vehicle is controlled to exit a drifting state, automation of exiting from the drifting state can be implemented, without requiring a user to frequently adjust a moving direction or a vehicle head orientation of the virtual vehicle through a direction adjustment control, thereby simplifying user operation. Increasing a decreasing speed of the drift angle of the virtual vehicle through the throttle control speeds up the exit of the virtual vehicle from the drifting state, and improve drifting-exit efficiency of the virtual vehicle. In addition, controlling the virtual vehicle through the throttle control to accelerate provides a moving manner of drifting and acceleration, so that moving manners of the virtual vehicle is enriched.

For the apparatus provided in the foregoing embodiments, when implementing the functions of the apparatus, only division of the function modules is described by using examples. During practical application, the functions are completed by different function modules as required. In other words, an internal structure of the device is divided into different function modules to complete all or some of the functions described above. In addition, the apparatus provided in the foregoing embodiments and the method embodiments fall within the same conception. For details of a specific implementation process, reference is made to the method embodiments. Details are not described herein again.

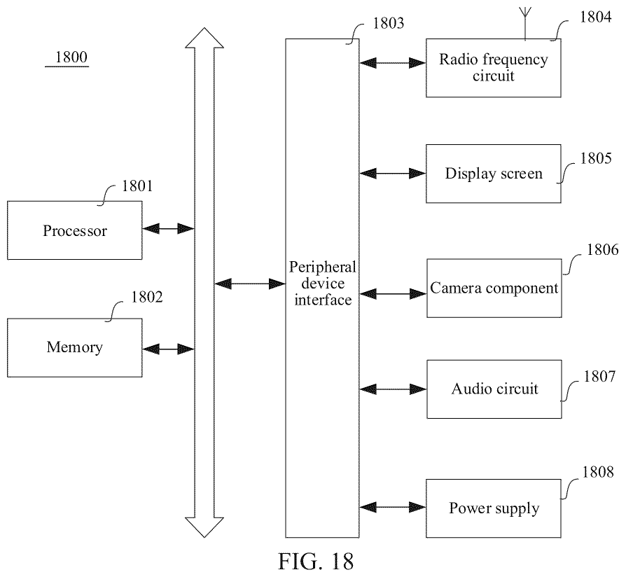

FIG. 18 shows a terminal device 1800 according to an embodiment of this application. The terminal device 1800 may be a mobile phone, a tablet computer, a game console, an e-book reader, a multimedia playback device, a wearable device, or a PC. This terminal device 1800 is configured to implement the functions of the foregoing virtual vehicle control method. Specifically,
the terminal device 1800 generally includes a processor 1801 and a memory 1802.

The processor 1801 may include one or more processing cores, for example, a 4-core processor or an 8-core processor. The processor 1801 may be implemented in at least one hardware form of digital signal processing (DSP), a field programmable gate array (FPGA), or a programmable logic array (PLA). The processor 1801 may alternatively include a main processor and a coprocessor. The main processor is a processor configured to process data in an awake state, and is also referred to as a central processing unit (CPU). The coprocessor is a low-power-consumption processor configured to process data in a standby state. In some embodiments, the processor 1801 may be integrated with a graphics processing unit (GPU). The GPU is configured to render and draw content that needs to be displayed on a display screen. In some embodiments, the processor 1801 may further include an artificial intelligence (AI) processor. The AI processor is configured to process computing operations related to machine learning.

The memory 1802 may include one or more computer-readable storage media. The computer-readable storage medium may be non-transient. The memory 1802 may further include a high-speed random access memory and a nonvolatile memory, for example, one or more disk storage devices or flash storage devices. In some embodiments, the non-transient computer-readable storage medium in the memory 1802 is configured to store at least one instruction, at least one program, a code set, or an instruction set. The at least one instruction, the at least one program, the code set, or the instruction set is configured to be executed by one or more processors to implement the foregoing interface display method.

In some embodiments, the terminal device 1800 may further include a peripheral device interface 1803 and at least one peripheral device. The processor 1801, the memory 1802, and the peripheral device interface 1803 may be connected through a bus or a signal line. Each peripheral device may be connected to the peripheral device interface 1803 through the bus, the signal line, or a circuit board. Specifically, the peripheral device includes at least one of a radio frequency circuit 1804, a display screen 1805, a camera component 1806, an audio circuit 1807, or a power supply 1808.

A person skilled in the art may understand that the structure shown in FIG. 18 does not constitute a limitation to the terminal device 1800, and the terminal device may include more or fewer components than those shown in the figure, or some components may be combined, or a different component deployment may be used.

In an exemplary embodiment, a non-transitory computer-readable storage medium is provided, having a computer program stored thereon, the computer program, when executed by a processor, implementing the foregoing virtual vehicle control method.

In some embodiments, the computer-readable storage medium may include a read only memory (ROM), a random access memory (RAM), a solid state drive (SSD), an optical disc, or the like. The random access memory may include a resistance random access memory (ReRAM) and a dynamic random access memory (DRAM).

In an exemplary embodiment, a computer program product is further provided, including computer instructions stored in a computer-readable storage medium, a processor of a terminal device reading the computer instructions from the computer-readable storage medium, and the processor executing the computer instructions, to cause the terminal device to perform the foregoing virtual vehicle control method.

“Plurality of” mentioned in the specification means two or more. “And/or” describes an association relationship between associated objects and indicates that three relationships may exist. For example, A and/or B may represent the following three cases: Only A exists, both A and B exist, and only B exists. The character “/” in this specification generally indicates an “or” relationship between the associated objects. In addition, the operation numbers described in this specification merely exemplarily show a possible execution sequence of the operations. In some other embodiments, the operations may not be performed in a number sequence. For example, two operations with different numbers may be performed simultaneously, or two operations with different numbers may be performed in a sequence contrary to the sequence shown in the figure, which is not limited in embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A virtual vehicle control method performed by a computer device, the method comprising:
displaying a virtual vehicle in a drifting state in which a drift angle of the virtual vehicle is greater than a first threshold;
in response to an operation on a first brake control, gradually decreasing the drift angle of the virtual vehicle;
in response to a first operation on a throttle control, accelerating the virtual vehicle and the decreasing of the drift angle of the virtual vehicle; and
when the drift angle of the virtual vehicle is less than the first threshold, controlling the virtual vehicle to exit the drifting state.

2. The method according to claim 1, wherein the accelerating the decreasing of the drift angle of the virtual vehicle comprises:
increasing grip of the virtual vehicle, the grip being in positive correlation with the decreasing of the drift angle.

3. The method according to claim 1, wherein the accelerating the virtual vehicle comprises:
superimposing an additional first acceleration on a first base acceleration of the virtual vehicle, to obtain a first target acceleration of the virtual vehicle; and
accelerating the virtual vehicle based on the first target acceleration.

4. The method according to claim 1, wherein the gradually decreasing the drift angle of the virtual vehicle comprises:
obtaining a target vehicle head orientation of the virtual vehicle at a next timestamp, a time interval between two adjacent timestamps being a unit time;
determining a target moving direction of the virtual vehicle at the next timestamp based on the target vehicle head orientation, an included angle between the target moving direction and the target vehicle head orientation being smaller than an included angle between a moving direction and a vehicle head orientation at a current timestamp; and
controlling the virtual vehicle to move at the next timestamp based on the target moving direction.

5. The method according to claim 1, wherein the method further comprises:
accelerating the virtual vehicle within first duration from an exit moment of the drifting state.

6. The method according to claim 1, wherein the method further comprises:
when a second operation on the throttle control is detected, accelerating the virtual vehicle within duration of the second operation; and
when the duration of the second operation reaches a maximum response value from an exit moment of the drifting state, displaying prompt information configured for indicating that a full throttle skill is triggered.

7. The method according to claim 1, wherein the method further comprises:
when the drift angle of the virtual vehicle is less than a second threshold, accelerating the virtual vehicle and the decreasing of the drift angle of the virtual vehicle; and
displaying prompt information configured for indicating that a slingshot exit skill is triggered.

8. The method according to claim 1, wherein the method further comprises:
when the drift angle of the virtual vehicle is greater than a third threshold, determining that the virtual vehicle is in an out-of-control state; and
controlling the virtual vehicle to switch from the out-of-control state to a grip-restored state.

9. The method according to claim 1, wherein the method further comprises:
when the drift angle of the virtual vehicle is greater than a second threshold and less than a third threshold, gradually decreasing the drift angle of the virtual vehicle and accelerating the virtual vehicle based on a first base acceleration of the virtual vehicle.

10. The method according to claim 1, wherein the method further comprises:
when it is detected that a direction adjustment control and a second brake control are both in a triggered state, controlling the virtual vehicle to enter the drifting state.

11. A computer device, comprising a processor and a memory, the memory having a computer program stored therein, and the computer program being loaded and executed by the processor and causing the computer device to perform a virtual vehicle control method including:
displaying a virtual vehicle in a drifting state in which a drift angle of the virtual vehicle is greater than a first threshold;
in response to an operation on a first brake control, gradually decreasing the drift angle of the virtual vehicle;
in response to a first operation on a throttle control, accelerating the virtual vehicle and the decreasing of the drift angle of the virtual vehicle; and
when the drift angle of the virtual vehicle is less than the first threshold, controlling the virtual vehicle to exit the drifting state.

12. The computer device according to claim 11, wherein the accelerating the decreasing of the drift angle of the virtual vehicle comprises:
increasing grip of the virtual vehicle, the grip being in positive correlation with the decreasing of the drift angle.

13. The computer device according to claim 11, wherein the accelerating the virtual vehicle comprises:
superimposing an additional first acceleration on a first base acceleration of the virtual vehicle, to obtain a first target acceleration of the virtual vehicle; and
accelerating the virtual vehicle based on the first target acceleration.

14. The computer device according to claim 11, wherein the gradually decreasing the drift angle of the virtual vehicle comprises:
obtaining a target vehicle head orientation of the virtual vehicle at a next timestamp, a time interval between two adjacent timestamps being a unit time;
determining a target moving direction of the virtual vehicle at the next timestamp based on the target vehicle head orientation, an included angle between the target moving direction and the target vehicle head orientation being smaller than an included angle between a moving direction and a vehicle head orientation at a current timestamp; and
controlling the virtual vehicle to move at the next timestamp based on the target moving direction.

15. The computer device according to claim 11, wherein the method further comprises:
when a second operation on the throttle control is detected, accelerating the virtual vehicle within duration of the second operation; and
when the duration of the second operation reaches a maximum response value from an exit moment of the drifting state, displaying prompt information configured for indicating that a full throttle skill is triggered.

16. The computer device according to claim 11, wherein the method further comprises:
when the drift angle of the virtual vehicle is less than a second threshold, accelerating the virtual vehicle and the decreasing of the drift angle of the virtual vehicle; and
displaying prompt information configured for indicating that a slingshot exit skill is triggered.

17. The computer device according to claim 11, wherein the method further comprises:
when the drift angle of the virtual vehicle is greater than a third threshold, determining that the virtual vehicle is in an out-of-control state; and
controlling the virtual vehicle to switch from the out-of-control state to a grip-restored state.

18. The computer device according to claim 11, wherein the method further comprises:
when the drift angle of the virtual vehicle is greater than a second threshold and less than a third threshold, gradually decreasing the drift angle of the virtual vehicle and accelerating the virtual vehicle based on a first base acceleration of the virtual vehicle.

19. The computer device according to claim 11, wherein the method further comprises:
when it is detected that a direction adjustment control and a second brake control are both in a triggered state, controlling the virtual vehicle to enter the drifting state.

20. A non-transitory computer-readable storage medium, having a computer program stored thereon, the computer program being loaded and executed by a processor of a computer device and causing the computer device to perform a virtual vehicle control method including:
displaying a virtual vehicle in a drifting state in which a drift angle of the virtual vehicle is greater than a first threshold;
in response to an operation on a first brake control, gradually decreasing the drift angle of the virtual vehicle;
in response to a first operation on a throttle control, accelerating the virtual vehicle and the decreasing of the drift angle of the virtual vehicle; and
when the drift angle of the virtual vehicle is less than the first threshold, controlling the virtual vehicle to exit the drifting state.
